(19) United States
(12) Patent Application Publication
(10) Pub. No.: US 2011/0186522 A1
(43) Pub. Date: Aug. 4, 2011

(54) REMOVAL OF NUISANCE ANION AND ANIONIC MATERIALS USING POLYALKYLENEIMINES SUCH AS POLYETHYLENEIMINE

(75) Inventor: DEAN F. MARTIN, Tampa, FL (US)

(73) Assignee: UNIVERSITY OF SOUTH FLORIDA, Tampa, FL (US)

(21) Appl. No.: 12/973,836

(22) Filed: Dec. 20, 2010

Related U.S. Application Data
(60) Provisional application No. 61/287,984, filed on Dec. 18, 2009.

(51) Int. Cl. B01D 35/00

(52) U.S. Cl. 210/683; 210/198.1

(57) ABSTRACT

The present invention features a method of removing one or more nuisance anionic materials, such as pharmaceuticals and dyes, from a solution, such as wastewater. Related aspects of the invention include an apparatus and kits for carrying out the methods of the invention.

### CROSS-REFERENCE TO RELATED APPLICATION

The present application claims the benefit of U.S. Application Ser. No. 61/287,984, filed Dec. 18, 2009, which is hereby incorporated by reference herein in its entirety, including any figures, tables, nucleic acid sequences, amino acid sequences, and drawings.

### BACKGROUND OF THE INVENTION

The volume and cost involved in a clean-up are challenging. Lumetta (Lumetta, G. J. The problem with anions in the DOE Complex. In Fundamentals and Applications of Anion Separations; Moyer, B. A.; Singh, R. P. Eds.; Kluwer Academic/Plenum New York. 2004; 107-114) noted that 3.4×10⁵ m³ of high-level wastes are stored in tanks at four sites (Savannah River, Hanford, Idaho National Engineering and Environmental Laboratory, and Oak Ridge). The cost was estimated at $227 billion and the time at 70 years (U.S. Department of Energy. 1996. Baseline Environmental Management Report, at U.S. Department of Energy website: worldwideweb.em.doe.gov/bemr96/index.html (Accessed August 2008)).

Vitrification as an option suffers from solubility problems, notably the low solubility of sulfate (ca 1%) or phosphate ions in borosilicate glass. (Eller, L. R.; Stepien, M.; Fowler, C. J.; Lee, J. T.; Sessler, J. L.; Moyer, B. A. Octamethyl-octaundecylcyclo[8]pyrrole: A promising sulfate anion extractant. J. Am. Chem. Soc. 2007, 129, 11020-11021; Lumetta, G. J. The problem with anions in the DOE Complex. In Fundamentals and Applications of Anion Separations; Moyer, B. A.; Singh, R. P. Eds.; Kluwer Academic/Plenum New York. 2004; 107-114). Phosphate forms an insoluble alkali-phosphate phase in the joule melter at a low P₂O₅ concentration (ca 2.5 wt %). These melters are electrically powered glass-making furnaces in which the molten glass itself carries the electric current and is thereby heated. (National Research Council. Nuclear Wastes: Technologies for Separations and Transmutation. National Academy Press. Washington, D.C. 1996; 87-98) Also, sulfate salts can form separate phases in the glass melter. Once such phases segregate, the dissolution is exceedingly slow. In addition, ion aggregates tend to be corrosive on the materials that form the melters, as well as perhaps increasing the rate of steam explosions and the rate of radionuclide volatility. (Lumetta, G. J. The problem with anions in the DOE Complex. In Fundamentals and Applications of Anion Separations; Moyer, B. A.; Singh, R. P. Eds.; Kluwer Academic/Plenum New York. 2004; 107-114; Li, H.; Hrma, P.; Vienna, J. D. Sulfate retention and segregation in simulated radioactive waste borosilicate glass. Ceram Trans. 2001, 119, 237-246).

Nitrate and nitrite ions also represent a disposal problem. (Lumetta, G. J. The problem with anions in the DOE Complex. In Fundamentals and Applications of Anion Separations; Moyer, B. A.; Singh, R. P. Eds.; Kluwer Academic/Plenum New York. 2004; 107-114). Nitrate ions are present as major components in tank wastes. Nitrite ions are also a major waste component because the ions are deliberately added to the tanks for corrosion control (Table 1). Nitrate and nutrient ions need to be removed before vitrification; otherwise they become a problem that must be addressed as NO off gases from the melters.

TABLE 1
Concentrations of significant anions used in the matrix eluant

| | Weight ratio | Component, | |
|---|---|---|---|
| Component | Component/sulfate | ppm | Component form |
| Sulfate | 1 | 30 | anh. Na₂SO₄ |
| Phosphate | 4.5 | 135 | anh Na₂HPO₄ |
| Nitrate | 0.6 | 18 | NaNO₃ |
| Nitrite | 5 | 150 | NaNO₂ |

Techniques for removing nitrate, nitrite, and sulfate have been under investigation for some time, especially highly selective methods. (Supramolecular Chemistry of Anions, Bianchi, A.; Bowman-James, K.; Garcia-Espana, E. Eds.; Wiley-VCH: New York, 1997; Steed, J. W; Atwood, J. L. Supramolecular Chemistry, Wiley, New York, 2000; Fundamentals and Applications of Anion Separations; Bianchi, A.; Bowman-James, K.; Garcia-Espana, E.; Eds.; Kluwer Academic/Plenum: New York. 2004; Sessler, J. L.; Gale, P. A.; Cho, W. S. Synthetic Anion Receptor Chemistry; Royal Society of Chemistry: London, 2006).

Efforts have been directed toward achieving specificity in anion removal by solvent extraction. For example Eller and co-workers (Eller, L. R.; Stepien, M.; Fowler, C. J.; Lee, J. T.; Sessler, J. L.; Moyer, B. A. Octamethyl-octaundecylcyclo[8]pyrrole: A promising sulfate anion extractant. J. Am. Chem. Soc. 2007, 129, 11020-11021) synthesized an azacage molecule that was selective toward sulfate.

### BRIEF SUMMARY OF THE INVENTION

Octolig®, a commercially available material (a polyethyleneimine covalently attached to high surface-area silica gel, CAS Registry numbver 404899-06-5), is noted for the ability to remove transition metal ions from aqueous solutions, and the removal of anions is a novel, recent discovery. Removal of such anions as nitrate, nitrite, sulfate, and phosphate has implications in converting atomic wastes to glassy materials (vitrification) for long-term strorage. Removal of arsenic, nitrate, nitrite, phosphate, selenite, or perchlorate ions has implications for water treatment. Removal of organic materials containing suitable anions has applications for treatment of water to remove nuisance pharmaceuticals that are presently incompletely removed. It is believed that the anions are removed by encapsulation with appropriate adjustment of pH.

Removal of nuisance anions includes, but is not limited to, arsenate, nitrate, phosphate, sulfate, perchlorate for waste or water treatment, and removal of selected pharmaceuticals that contain suitable anionic groups or that can be converted to suitable anionic moieties by treatment with sulfur trioxide, for example.

Mixtures of sodium salts of nitrate, nitrite, sulfate, and phosphate were prepared in relative amounts present in atomic waste containers with a view to effect removal by chromatography over Octolig®. Separation was attempted using aqueous solutions and column chromatography with Octolig®. It is proposed that this material is capable of removing the anions by encapsulation. Matrix effects were tested by varying the relative concentrations. Rates of elution were varied five-fold without adverse effect. The order of selectivity was found to be phosphate>sulfate>nitrite>nitrate through experiments altering the volume and relative concentrations. Quantitative removal of all anions was achieved given reasonable volumes of Octolig®. An effort at regeneration by altering the pH of the eluant indicated the stability of the encapsulated anions.

The invention has applications in home water treatment systems, due to locations where copper pipes are in use and in contact with “aggressive” water. Water containing nuisance anions (arsenite, nitrate, nitrite, phosphate, sulfate selenite, perchlorate, etc), can simply be passed over a column of material comprising polyalkyleneimine moieties covalently attached to a substrate such as high surface area silica (for example, Octolig® material) under appropriate conditions, and high degrees (approaching 100%) of removal have been noted. The system also has applications in home systems connected to wells that contain higher levels of anions, such as arsenic, for example. Another application would be in areas of the western United States where the ground water is contaminated with uranium (as anionic species) or other nuisance anions like selenium in California that prevent the land from being developed for homes. Given the appropriate technology that this invention represents, the value of the land would increase significantly. Another application is in West Virginia where the water supply is contaminated with selenium and other species (from mining activities presumably) that are not being presently removed and/or not being allowed to be used as a source of drinking water, owing to the contamination and/or the level of contaminants.

One aspect of the invention features a method of removing one or more anions from a solution, comprising contacting the solution with branched polyalkyleneimine moieties attached to a substrate (a support) under conditions that allow association between the polyalkyleneimine moieties and one or more anions if present in the solution. In some embodiments, the branched polyalkyleneimine has at least one tertiary amino group and at least one primary or secondary amino group, with the polyalkyleneimine having a molecular weight of at least about 400. In some embodiments, the branched polyalkyleneimine is selected from the group consisting of branched polyethyleneimine, branched polypropyleneimine, branched polybutyleneimine and branched polypentyleneimine (see, for example, U.S. Pat. No. 5,914,044 (Lindoy et Immobilized branched polyalkyleneimines”, which is incorporated herein by reference in its entirety).

The substrate may be any supporting surface permitting attachment of the polyalkyleneimine moieties and removal of anions from solution. Preferably, the polyalkyleneimine moieties are covalently attached to the substrate via a linking group. In some embodiments, the substrate is an inorganic support selected from silicate, silica gel, sand, alumina, or glass (see, for example, U.S. Pat. No. 5,914,044). Preferably, the substrate comprises silica. In some embodiments, the substrate comprises an aluminum derivative (for example, using triethoxyaluminum as a starting material). In some embodiments, the substrate comprises a gel or particles. Preferably, in those embodiments in which the substrate comprises silica, the silica substrate is a high surface-area silica gel. In preferred embodiments, the polyalkyleneimine moieties are polyethyleneimines, the substrate is a high surface-area silica gel, and the polyalkyleneimine moieties are covalently attached to the high surface-area silica gel. For example, the material may be Octolig®.

Typically, the solution will be an aqueous solution. In some embodiments, the solution comprises hospital wastewater effluent, wastewater treatment plant effluent, medical research facility wastewater effluent, surface water, or ground water.

The solution and polyalkyleneimine moieties are brought into contact under conditions that allow association between the polyalkyleneimine moieties and one or more anions if present in the solution. Without being bound by theory, it is proposed that the association between the polyalkyleneimine moieties and the one or more anions represents a encapsulation of the anion, as represented by the one-arm and two-arm encapsulation models shown in FIGS. 1A-1B. Preferably, the conditions that allow the association between the polyalkyleneimine moieties and one or more anions comprises the solution having a pH of at least 7.0, with an upward pH that does not degrade or otherwise negate the anion-removal capacity of the polyalkyleneimine moieties. In some embodiments, the solution has a pH greater than 7.0. In some embodiments, the pH of the solution is within the range of 7.0-8.0.

The anion removal method may further comprise adjusting the pH of the solution (raising or lowering the pH) to a pH that allows association between the polyalkyleneimine moieties and the one or more anions, and wherein said adjusting is carried out prior to, or simultaneously with, said contacting. Thus, for example, the pH of the solution may be adjusted to at least 7.0 in some embodiments, to greater than 7.0 in some embodiments, and to within the range of 7.0-8.0 in some embodiments.

In some embodiments, the pH of the solution is a pH which allows association between the polethyleneimine moieties and one or more anions, but not removal of transition metal ions.

In some embodiments, the pH of the solution is a pH which allows association between the polethyleneimine moieties and one or more anions, and a pH which allows removal of transition metal ions.

In some embodiments, the solution does not contain transition metal ions. For example, the solution can be one which never contained transition metal ions, or the solution can be one in which transition metal ions were removed using Octolig® or another material/method.

In some embodiments, a solution is subjected to contact with a plurality of substrates with polyalkyleneimine moieties attached thereto, under the same conditions or under different conditions. The substrates may be arranged in series and/or in parallel. For example, the solution can be contacted with the polyalkyleneimine moieties of the substrates under varying conditions depending upon the target species for removal (e.g., anions, transition metal ions, or both).

The solution and the polyalkyleneimine moieties may be brought into contact with one another by any method that would allow association between the polyalkyleneimine moieties and anions of interest in the solution, and is not limited to any specific movement between the polyalkyleneimine moieties and/or the solution relative to each other. For example, contacting may comprise running (also referred to herein as passing) the solution through or over the polyalkyleneimine moieties, contacting may comprise moving the polyalkyleneimine moieties (attached to the substrate) into contact with the solution (the solution may be still or moving). In some embodiments, contacting comprises passing the solution through at least one ion-association composite, wherein the ion-association composite comprises the polyalkyleneimine moieties attached to a substrate such as a high-surface-area silica gel (the ion-association composite referring to the material that results from the appropriate reaction of the polyalkyleneimines and the substrate, and without wishing to be bound by theory, the ion-association referring to the reaction of the anion with one or more protons on the polyalkyleneimines). The ion-association composite may be used in a chromatography column. Preferably, the ion-association composite is packed into a column having a length sufficient for separation (for example, at least 5 cm in length).

Optionally, the method may further comprise subjecting the solution to electrochemistry after contacting the solution with the polyalkyleneimine moieties running the solution through the at least one ion-association composite.

Examples of target anions include, but are not limited to, arsenate, arsenite, nitrate, nitrite, phosphate, sulfate, selenate, selenite, perchlorate, and molybdate.

In some embodiments, the one or more anions are constituents of a compound comprising one or more functional groups capable of losing one or more protons to become anionic. In some embodiments, the one or more functional groups comprise at least a phenolic group, a carboxylic group, a sulfonic group, or a combination of two or more of the foregoing groups.

In some embodiments, the one or more anions comprise an active pharmaceutical ingredient (API), or a moiety of an API. As used herein, the APIs include, for example, so called small molecule chemical entities (small molecules) and macromolecules such as biologics (for example, polypeptides).

In some embodiments, the one or more anions comprise a dye, or a moiety of a dye.

In some embodiments, the anion, or compound of which the anion is a constituent, does not comprise a metal (e.g., a transition metal ion). In some embodiments, the anion, or compound of which the anion is a constituent, does not comprise a heavy metal. In some embodiments, the solution to be treated for removal of anions does not contain heavy metals. In some embodiments, the solution is not wastewater from an electroplating facility.

In some embodiments, the anion, or compound of which the anion is a constituent, comprises chromate or dichromate. In other embodiments, the anion, or compound of which the anion is a constituent, does not comprise chromate or dichromate.

The substrate with the attached polyalkyleneimine moieties may be periodically regenerated (the anions released elsewhere by extreme pH adjustment, for example, and reinstalled) or removed and replaced with fresh polyalkyleneimine moieties and substrate. Optionally, a sensor may be used to qualitatively or quantitatively detect the presence of captured or uncaptured anions.

Another aspect of the invention concerns an apparatus useful for carrying out the methods of the invention described herein (removing one or more anions from a solution), comprising branched polyalkyleneimine moieties attached to a substrate; and a pH adjuster (pH adjustment device). Preferably, the substrate is a high surface-area silica gel with the polyalkyleneimine moieties covalently attached thereto. In preferred embodiments, the polyalkyleneimine moieties are polyethyleneimines, the substrate is a high surface-area silica gel, and the polyalkyleneimine moieties are covalently attached to the high surface-area silica gel. In some embodiments, the apparatus further comprises a sensor that may be used to qualitatively or quantitatively detect the presence of captured or uncaptured anions. In some embodiments, the apparatus further comprises a pH sensor which reports the pH of the solution at the substrate bearing the polyalkyleneimine moieties or at a point prior to contact with the substrate.

Another aspect of the invention concerns a kit useful for carrying out the methods of the invention described herein (removing one or more anions from a solution), comprising branched polyalkyleneimine moieties attached to a substrate, and printed instructions for carrying out anion removal in accordance with the methods of the invention. In some embodiments, the kit further comprises an acid for lowering the pH of the solution, a base for raising the pH of the solution, or both an acid and a base. Preferably, the substrate is a high surface-area silica gel with the polyalkyleneimine moieties covalently attached thereto. In preferred embodiments, the polyalkyleneimine moieties are polyethyleneimines, the substrate is a high surface-area silica gel, and the polyalkyleneimine moieties are covalently attached to the high surface-area silica gel.

### BRIEF DESCRIPTION OF THE DRAWINGS

For a fuller understanding of the invention, reference should be made to the following detailed description, taken in connection with the accompanying drawings, in which:

FIGS. 1A-1B show postulated structures showing encapsulated sulfate ion in (FIG. 1A) a double-arm structure of Octolig® and (FIG. 1B) a single-arm version. Presumably, protonation of selected nitrogens would enhance the firmness of the encapsulation.

FIG. 2 shows the postulated mechanism of encapsulation of anions (Aⁿ⁻) by Octolig® showing a one-arm model (Stull et al., J. Environ. Sci. Hlth., Part A 44: 1551, 2009).

FIG. 3 shows the structure of xanthenylbenzene dyes. Rose Bengal (R¹=I; R²=Cl), Erythrosin (R¹=I; R²=H), Eosin Y ((R¹=Br; R²=H).

FIG. 4 shows the structure of methylene blue, an antimethemoglobinemic (website of Anon. Methylene Blue (71-783-4) Chemical Book, at chemicalbook.com: worldwideweb.chemicalbook.com/ProductMSDSDetailCB2748858_EN.htm Accessed Apr. 22, 2010).

FIG. 5 shows the structure of zinc phthalocyaninetetrasolfnate (ZPS).

FIG. 6 shows the structure of Lissamine Green B.

FIG. 7 shows the structure of Amoxicillin.

FIG. 8 shows the percent removal of aqueous Rose Bengal by chromatography with Octolig® as a function of initial pH.

FIG. 9 shows the percent removal of aqueous ZPS by chromatography with Octolig® as a function of initial pH.

### DETAILED DISCLOSURE OF THE INVENTION

Recent research directed at anion removal, in contrast, has utilized a commercially available immobilized ligand Octolig® (I) and metal derivatives, including the copper(II) derivative called Cuprilig (II). (Martin, D. F.; O'Donnell, L.; Martin, B. B.; Alldredge, R. Removal of aqueous arsenic using iron attached to immobilized ligands (IMLIGS). J. Environ. Sci. Health PtA 2007, 42, 97-102; Martin, D. F.; O'Donnell, L.; Martin, B. B.; Alldredge, R.; Removal of aqueous nuisance anions with Ferrilig. J. Environ. Sci. Health Pt A 2008, 43, 700-704 Martin, D. F.; Aguinaldo, J. S.; Kondis, N. P.; Stull, F. W.; O'Donnell, L. F.; Martin, B. B; Alldredge., R. L; Comparison of effectiveness of removal of nuisance anions by metalloligs, metal derivatives of Octolig®, J. Environ. Sci. Health Pt. A 2008, 43, 1296-1302; Martin, D. F.; Kondis, N. P.; Alldredge, R. L. Effectiveness of removal of aqueous perchlorate by Cuprilig, a copper(II) of Octolig® J. Environ. Sci. Health Pt. A, 2009, 44, 188-191). (II, Equation 1).

-0₃Si—O—Si—CH₂CH₂CH₂NHCH₂CH₂[NHCH₂CH₂]ₙNH₂+Cu(II)→II (1)

(I)

These materials and others were screened for the ability to remove nuisance anions. Specifically, using Ferrilig, the iron(III) derivative of Octolig®, the inventors were able to successfully remove arsenic (as Na₂HAsO₄.7H₂0), chromium as sodium chromate, molybdenum as (NH₄)₆Mo₇O₂₄.4H₂O, and selenium as Na₂Se0₃ with success. (Martin, D. F.; O'Donnell, L.; Martin, B. B.; Alldredge, R.; Removal of aqueous nuisance anions with Ferrilig. J. Environ. Sci. Health Pt A 2008, 43, 700-704). The elements, their initial concentrations and their percentage removal (parenthetically) were: As (280 ppb, 99%), Cr (50.6 ppm, 95.5%), Mo (50.7 ppm, 94.6%), Se (258 ppm, 99.9%). (Martin, D. F.; O'Donnell, L.; Martin, B. B.; Alldredge, R.; Removal of aqueous nuisance anions with Ferrilig. J. Environ. Sci. Health Pt A 2008, 43, 700-704).

The present study evaluates the use of polyethyleneimine moieties covalently attached to a silica substrate, such as plain Octolig®, which is commercially available and described in U.S. Pat. No. 5,914,044 (Lindoy et al., Immobilized branched polyalkyleneimines”), does not require the use of a non-aqueous solvent (a requirement of solvent extraction), and has the potential of removing anions, based on previous results with perchlorate ion. (Martin, D. F.; Kondis, N. P.; Alldredge, R. L. Effectiveness of removal of aqueous perchlorate by Cuprilig, a copper(II) of Octolig® J. Environ. Sci. Health Pt. A, 2009, 44, 188-191).

The following publications are incorporated herein by reference in their entirety: Martin D F, et al. “Removal of selected nuisance anions by Octolig” J Environ Sci Health A Tox Hazard Subst Environ Eng., January 2010; 45(9):1144-1149; Stull F W and Martin D F “Comparative ease of separation of mixtures of selected nuisance anions (nitrate, nitrite, sulfate, phosphate) using Octolig” J Environ Sci Health A Tax Hazard Suhst Environ Eng, December 2009, 44(14):1545-1550; Martin D F et al., “Effectiveness of removal of aqueous perchlorate by Cuprilig, a copper(II) derivative of Octolig” J Environ Sci Health A Tax Hazard Suhst Environ Eng., February 2009, 44(2):188-191; Martin D F et al. “Comparison of effectiveness of removal of nuisance anions by metalloligs, metal derivatives of Octolig” J Environ Sci Health A Tax Hazard Subst Environ Eng, September 2008, 43(10:1296-302; Martin D F et al. “Removal of nuisance aqueous anions with Ferrilig” J Environ Sci Health A Tox Hazard Subst Environ Eng, June 2008, 43(7):700-4; Martin D F et al. “Removal of aqueous arsenic using iron attached to immobilized ligands (IMLIGs)” J Environ Sci Health A Tox Hazard Subst Environ Eng, January 2007, 42(1):97-102; and Chang, W F et al. “Use of Model Compounds to Study Removal of Pharmaceuticals Using Octolig®” Technology and Innovation, 2010, 12:71-78.

One aspect of the invention features a method of removing one or more anions from a solution, comprising contacting the solution with branched polyalkyleneimine moieties attached to a substrate (a support) under conditions that allow association between the polyalkyleneimine moieties and one or more anions if present in the solution. In some embodiments, the branched polyalkyleneimine has at least one tertiary amino group and at least one primary or secondary amino group, with the polyalkyleneimine having a molecular weight of at least about 400. In some embodiments, the branched polyalkyleneimine is selected from the group consisting of branched polyethyleneimine, branched polypropyleneimine, branched polybutyleneimine and branched polypentyleneimine (see, for example, U.S. Pat. No. 5,914,044 (Lindoy et al., Immobilized branched polyalkyleneimines”, which is incorporated herein by reference in its entirety).

The anion removal method may further comprise adjusting the pH of the solution (raising or lowering the pH) to a pH that allows association between the polyalkyleneimine moieties and the one or more anions, and wherein said adjusting is carried out prior to, or simultaneously with, said contacting. Thus, for example, the pH of the solution may be adjusted to at least 7.0 in some embodiments, to greater than 7.0 in some embodiments, and to within the range of 7.0-8.0 in some embodiments.

The pH of the solution may be adjusted up or down to provide a pH adjusted solution (for example, pH adjusted water) using methods known in the art including pH adjusters (pH adjustment devices) and pH adjustment agents. Any pH adjusting agent that has the effect of altering the pH of the solution may be used in the present invention, such as one or more acids or bases. For example, bases such as lime (calcium oxide; CaO), sodium hydroxide, potassium hydroxide, ammonium hydroxide, lithium hydroxide can be used to raise pH. Suitable acids that are able to adjust the pH of the solution include, but are not limited to, organic and inorganic acids. Preferably the acid is an inorganic acid, such as hydrochloric acid.

The invention includes an apparatus for removing one or more anions from a solution, such as wastewater, the apparatus comprising branched polyalkyleneimine moieties attached to a substrate; and a pH adjuster. The apparatus may include a housing for holding the components, the housing being composed of a material suitable for containment and transport of the solution. The apparatus may further comprise an inlet for the solution to be brought into contact with the polyalkyleneimine moieties for anion removal, and an outlet for the solution. In some embodiments, the solution that enters through the inlet will be a pH adjusted solution. The apparatus of the invention may also include a pH adjusting region. The pH adjusting region will be understood to be any region, area or part of the apparatus in which the solution is brought into contact with the pH adjusting agent. By way of example only, the region, area or part of the apparatus may be a tank, pipe or cartridge in which the solution is temporarily held or through which the solution passes. The solution may, for instance, be dosed with a pH adjusting agent in a tank or pipe, e.g. by way of in-line pipe injection, or alternatively brought in contact with a pH adjusting agent such as an ion exchange medium in a cartridge.

In some embodiments, the apparatus further comprises a sensor that may be used to qualitatively or quantitatively detect the presence of captured or uncaptured anions. In some embodiments, the apparatus further comprises a pH sensor which reports the pH of the solution at the substrate bearing the polyalkyleneimine moieties or at a point prior to contact with the substrate.

It will be appreciated that in addition to adjusting the pH of the solution, other specific contaminants may be removed from the solution. The solution may undergo one or more purification steps before and/or after, pH adjustment, before and/or after contact with the polyalkyleneimines, and before and/or after removal of anions. For example, the solution may be filtered and/or undergo a particulate removal step. Suitable filters include, but are not limited, to stainless steel mesh filters, hair and lint filters, sand filters, steel sinters, bag filters, and pleated filters. Preferably, the filters are back-washable.

When the pH adjusting agent is an ion exchange medium, biological contaminants may be removed by way of adsorption onto the medium in accordance with what is presently known in the art. Biological contaminants including but not limited to Cryptosporidium, Giardia, Cholera, E. coli, bacteria, viruses, algae and yeast may be removed by an appropriate ion exchange medium in accordance with known methods.

Examples of target anions include, but are not limited to, arsenate, arsenite, nitrate, nitrite, phosphate, sulfate, selenate, selenite, perchlorate, and molybdate.

In some embodiments, the one or more anions are constituents of a compound comprising one or more functional groups capable of losing one or more protons to become anionic. In some embodiments, the one or more functional groups comprise at least a phenolic group, a carboxylic group, a sulfonic group, or a combination of two or more of the foregoing groups.

In some embodiments, the one or more anions comprise an active pharmaceutical ingredient (API), or a moiety of an API. APIs include, for example, so called small molecule chemical entities (small molecules) and macromolecules such as biologics (for example, polypeptides). APIs, as used herein, is intended broadly to include any substance or mixture of substances intended to be used in the manufacture of a drug product and that, when used in the production of a drug, becomes an active ingredient in the drug product. Such substances are intended to furnish pharmacological activity or other direct effect in the diagnosis, cure, mitigation, treatment or prevention of disease or to affect the structure and function of the body. APIs that can be removed from a solution using the methods, apparatus, and kits of the invention include those having anionic groups in aqueous solutions, particularly those having at least one carboxylic, phosphate or sulfate group. For example, polypeptides (including peptides and proteins) having at least one carboxylic group can be removed. Examples of APIs include, but are not limited to, anti-cancer agents, antibiotics, anti-emetic agents, antiviral agents, anti-inflammatory and analgesic agents, anesthetic agents, anti-ulceratives, agents for treating hypertension, agents for treating hypercalcemia, agents for treating hyperlipidemia, etc., each of which has at least one carboxylic, phosphate or sulfate group in the molecule. Specific examples include insulin, calcitonin, growth hormone, granulocyte colony-stimulating factor (G-CSF), erythropoietin (EPO), bone morphogenic protein (BMP), interferon, interleukin, platelet derived growth factor (PDGF), vascular endothelial growth factor (VEGF), fibroblast growth factor (FGF), nerve growth factor (NGF), urokinase, etc., each of which has at least one carboxylic, phosphate or sulfate group in the molecule.

Solutions suitable for treatment using the methods, apparatus, and kits of the present invention include but are not limited to waters of rivers, dams, ground water, seawater, swimming pools and industrial and domestic waste water (including “grey water”). These waters may contain natural and/or synthetic anionic material to be removed. The invention provides a practical way of removing a range of such anionic materials from such water.

Typically, the solution will be an aqueous solution. In some embodiments, the solution comprises hospital wastewater effluent, wastewater treatment plant effluent, medical research facility wastewater effluent, surface water, or ground water. The method of the invention may be carried out at the site of these point sources or remote therefrom.

Preferably, the substrates with the attached polyalkyleneimine moieties are packaged into cartridges which may be gravity or pressure fed with the solution to be treated for removal of anions. Depending upon the application and scale, the cartridges can be arranged as columns, towers, tanks, or beds, for example.

For the majority of applications, the contact time between the polyalkyleneimine moieties and the solution will be minimal. The contact time, is, however, dependent on a variety of factors applicable to each use situation, such as cartridge size and flow-rate. The person skilled in the art will appreciate that a suitable contact time may be established through appropriate testing and evaluation.

All patents, patent applications, provisional applications, and publications referred to or cited herein, supra or infra, are incorporated by reference in their entirety, including all figures and tables, to the extent they are not inconsistent with the explicit teachings of this specification.

Following are examples which illustrate procedures for practicing the invention. These examples should not be construed as limiting. All percentages are by weight and all solvent mixture proportions are by volume unless otherwise noted.

### Materials and Methods for Example 1

Sources of reagents and materials. Octolig®, immobilized polyethyleneimines covalently attached to high-surface-area silica gel (CAS Registry number=404899-06-5) was a gift from Metre-General, Inc. and was used as received. Potassium nitrate, potassium nitrite and sodium sulfate (anhydrous) were obtained from Fisher; sodium dihydrogen phosphate was obtained from Mallinckrodt.

Analyses. Total dissolved solids (TDS) values, as ppm, were measured using a Fisher Scientific digital conductivity meter. The pH of aqueous samples was tested using an Orion model 290A pH/ISE meter with an Orion pH triode electrode. Buffers from Fisher Scientific were used to standardize the instrument. Nitrite, nitrate, and phosphate were assayed using appropriate HACH kits. Sulfate was analyzed by Evergreen Analytical Laboratory, Wheat Ridge, Colo.

Chromatography experiments. Aqueous samples of deionized (DI) water were prepared and subjected to column chromatography. As before, (Martin, D. F.; O'Donnell, L.; Martin, B. B.; Alldredge, R.; Removal of aqueous nuisance anions with Ferrilig. J. Environ. Sci. Health Pt A 2008, 43, 700-704; Martin, D. F.; Aguinaldo, J. S.; Kondis, N. P.; Stull, F. W.; O'Donnell, L. F.; Martin, B. B; Alldredge., R. L; Comparison of effectiveness of removal of nuisance anions by metalloligs, metal derivatives of Octolig®, J. Environ. Sci. Health Pt. A 2008, 43, 1296-1302; Martin, D. F.; Kondis, N. P.; Alldredge, R. L. Effectiveness of removal of aqueous perchlorate by Cuprilig, a copper(II) of Octolig® J. Environ. Sci. Health Pt. A, 2009, 44, 188-191) a Spectra/chron peristaltic pump was used to deliver aqueous samples to a CHEMGLASS chromatography column, 2 cm (id) by 31 cm and equipped with a glass frit and a Teflon stopcock. The column was packed with about 22 cm of Octolig®. Before packing, the solid was suspended in water, swirled, and the fines were decanted, a process that was repeated until no fines were observed. Water samples were chromatographed using a rate of 10 mL/min. Usually, the first three or four 50-mL aliquots of effluent were discarded, and later ones were used for analysis (Table 1). Total dissolved solids were measured, and used as a guide to assess a state of equilibrium.

In subsequent experiments to test for discrimination of separation, the packing length was reduced to 5 cm from 22 cm. Otherwise, all other aspects of the procedure remained the same, and results are recorded in Table 2.

TABLE 2
Standard: Effect of passage of samples over a 1.9-cm (id) column packed with
about 22 cm of Octolig ® at a rate of 10 mL/min (50-mL aliquots were collected)

| | | | TDS, ppm | | Species | Eluant | % |
|---|---|---|---|---|---|---|---|
| Species | Medium | Fraction | Initial | eluant | initial ppm* | ppm | removed |
| Sulfate | Stock | 5-7 | 36.2 | 36.5 | 29.0 | BDL† | >99 |
| Trial 1* | | | | | | | |
| Sulfate | Mixture* | 5, 7, 8 | 321 | 348 ± 3.2 | 29.9 | BDL | >99 |
| | | | | | 29.0 | BDL | >99 |
| Phosphate | | 5, 7, 8 | 321± | 348 ± 3.2 | 135 | BDL | >99 |
| Nitrate | | 5, 7, 8 | 321 | 348 ± 3.2 | 19 | 0.095 ± 0.17 | >99 |
| Nitrite | | 5, 7, 8 | 321 | 348 ± 3.2 | 53 | 0.072 ± 0.08 | >99 |
| Trial 2** | | | | | | | |
| Sulfate | Mixture | 5-7 | | 376 ± 3 | 30 | BDL | >99 |
| Phosphate | | 5-7 | | 376 ± 3 | 135 | BDL | >99 |
| Nitrogen | | 5-7 | | 376 ± 3 | 48.3 | 0.05 ± 0.01 | >99 |

*Analyzed value. Calculated values (ppm) were SO₄⁼, 30; PO₄³⁻, 135; NO₃⁻, 18; NO₂⁻, 123. TDS (obs) = 321 ppm. pH = 8.65
**Calculated values(ppm) were SO₄⁼, 30; PO₄³⁻, 135; NO₃⁻, 12; NO₂⁻, 150; TDS (obs) = 351
†BDL = Below detection limit

Regeneration study. This experiment was performed directly after the “Competition Study” experiment in which a solution containing large concentrations of sulfate, phosphate, nitrate, and nitrite was passed through 22 cm of Octolig, which presumably exhausted the Octolig® capacity for that column. That column containing the saturated Octolig® was washed with 250 mL of deionized water, and 50-mL fractions were collected. The fifth fraction of deionized water washing was tested for the presence of phosphate- and nitrogen-containing species; none could be detected.

TABLE 6
Competition study: Effect of passage of ion samples over a 1.9-cm (id)
column packed with about 22 cm of Octolig ® at a rate of 10 mL/min
(50-mL aliquots were collected)

| | TDS, | | | [NO₂⁻], | |
|---|---|---|---|---|---|
| Fraction | ppm | [PO₄³⁻], ppm | [SO₄⁼], ppm | ppm | [NO₃⁻], ppm |
| 1 | 880 | BDL | | BDL | BDL |
| 2 | 1890 | BDL | | BDL | BDL |
| 3 | 1950 | BDL | | 122 | 12.8 |
| 4 | 1910 | BDL | | 592 ± 0 | ~0 |
| 5 | 1890 | 30 | 3.1 | 872 ± 49 | 198 ± 6 |
| 6 | 1830 | 220 | 58.2 | 619 ± 13 | 205 ± 47 |
| 7 | 1810 | 260 | 355 | 558 ± 0 | 66 ± 93 |

Initial concentrations (Hach kits): 650 ppm PO₄^{3-;} 533 ± 13 ppm NO₂⁻, 167 ± 106 ppm NO₃⁻; and 500 ppm SO₄⁼ (calculated)

TABLE 7
Analysis of competition study (Table 6) units of ppm

| | [PO4³⁻] | | [SO₄⁼] | | [NO₂⁻] | | [NO₃⁻] | |
|---|---|---|---|---|---|---|---|---|
| Fraction | extra | removed | released | removed | released | removed | removed | released] |
| 3 | | | | | | | | |
| 4 | — | 650 | | | 69 | | | 525 |
| 5 | 30 | 620 | | 497 | 384 | | 74 | |
| 6 | 220 | 430 | | 442 | 87 | | 30 | |
| 7 | 260 | 390 | | 145 | 35 | | 136 | |

Equivalence: 95 ppm phosphate vs 96 ppm sulfate vs 46 ppm nitrite vs 62 ppm nitrate

Subsequently, the column was eluted with aqueous NaOH solution (pH 10.7); 50-mL fractions of eluant were collected and tested for the presence of phosphate and nitrite. Ten fractions were collected. Fractions 2 through 10 were shown to have a very slight concentration of phosphate (<1 ppm) and also a very slight concentration of nitrite (<5 ppm). Also, the pH of the eluant was roughly tested using the pH meter, and the pH of the eluant was <7.

### Example 1

### Removal of Nuisance Anions Using Octolig®

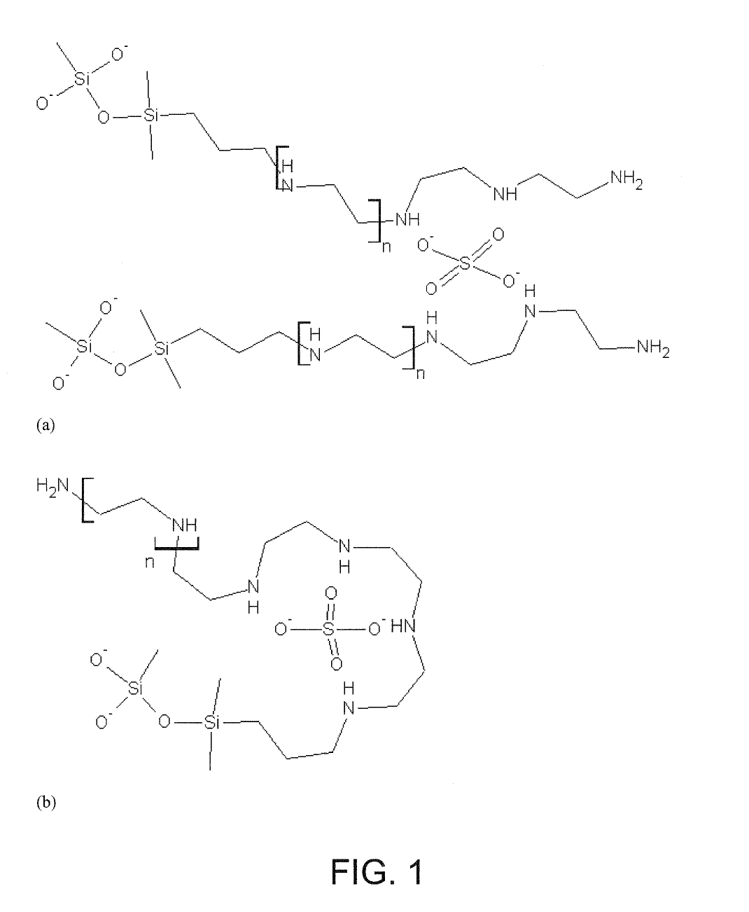

Studies (Martin, D. F.; O'Donnell, L.; Martin, B. B.; Alldredge, R. Removal of aqueous arsenic using iron attached to immobilized ligands (IMLIGS). J. Environ. Sci. Health PtA 2007, 42, 97-102; Martin, D. F.; O'Donnell, L.; Martin, B. B.; Alldredge, R.; Removal of aqueous nuisance anions with Ferrilig. J. Environ. Sci. Health Pt A 2008, 43, 700-704; Martin, D. F.; Aguinaldo, J. S.; Kondis, N. P.; Stull, F. W.; O'Donnell, L. F.; Martin, B. B; Alldredge., R. L; Comparison of effectiveness of removal of nuisance anions by metalloligs, metal derivatives of Octolig®, J. Environ. Sci. Health Pt. A 2008, 43, 1296-1302; Martin, D. F.; Kondis, N. P.; Alldredge, R. L. Effectiveness of removal of aqueous perchlorate by Cuprilig, a copper(II) of Octolig® J. Environ. Sci. Health Pt. A, 2009, 44, 188-191) have indicated the successful removal of anions by means of metal derivatives of Octolig® or metalloligs. Presumably the act of coordination of such transition metals would form rings, specifically macro-rings with involving two polyethyleneimine “arms” attached covalently to silica gel. What was less evident was that Octolig® alone could remove anions as was demonstrated for Cuprilig vs. Octolig® for perchlorate anion. (Martin, D. F.; Kondis, N. P.; Alldredge, R. L. Effectiveness of removal of aqueous perchlorate by Cuprilig, a copper(II) of Octolig® J. Environ. Sci. Health Pt. A, 2009, 44, 188-191). Admittedly the two “arms” attached to silica gel would not form a true ring but a nearly complete ring, or what might be loosely called a quasi-ring. Postulated structures are indicated (FIGS. 1A-1B) for the encapsulation of sulfate ion.

Concentrations given in Table 1 constitute a good starting point for considering some of the challenges of remediation of nuclear-related waste materials. For evident reasons of safety and research restrictions, at this stage of the research, the present inventors focused on an artificial system, i.e., the anions listed in Table 1 at the concentrations described elsewhere. (National Research Council. Nuclear Wastes: Technologies for Separations and Transmutation. National Academy Press. Washington, D.C. 1996; 87-98). Chiefly, there is a need to remove sulfate ion because of the needs imposed by vitrification, but also to remove nitrite ion (added as a corrosion inhibitor) as well. There may well be disagreement as to whether these must be removed one by one or whether two or more nuisance anions might be removed in a single operation. For example, the work of Eller and co-workers (Eller, L. R.; Stepien, M.; Fowler, C. J.; Lee, J. T.; Sessler, J. L.; Moyer, B. A. Octamethyl-octaundecylcyclo[8]pyrrole: A promising sulfate anion extractant. J. Am. Chem. Soc. 2007, 129, 11020-11021) was focused on a worthy goal of removing sulfate ion selectively by solvent extraction. In this study, of interest was an approach that would be as cheap and as effective as possible and the goal of selectivity was not a major one at this stage.

The data in Table 1 show that for the anions involved and at the concentrations suggested, (National Research Council. Nuclear Wastes: Technologies for Separations and Transmutation. National Academy Press. Washington, D.C. 1996; 87-98) good separation at this stage of the research of sulfate was achieved, i.e., >99% to below detectable levels. In addition, all other anions were quantitatively removed (i.e. >99%). Were the goal of the clean-up process to separate all nuisance anions by a convenient process, this experiment or set of experiments would be an outstanding success.

Realistically, however, the first of several problems arose: concentrations listed in Table 1 were a composite set with variations. This was addressed by looking at Trial 1 and Trial 2 (Table 3) in which the concentration of nitrite ion was increased in Trial 1 and Trial 2 (3.3-fold and 2.4-fold, respectively). Lower concentrations of nitrite (2.4-fold enhancement over the value in Table 2 were removed successfully (97% removal), a validation of the nitrite concentrations in Tables 1 and 2, but the higher concentration (3.3-fold) was less successful (67% or less). The column was re-packed in between Trials 1 and 2, so it may be concluded that the capacity of the column was exceeded by the excess nitrite.

TABLE 3
Nitrite concentration alteration: Effect of passage of augmented-ion
samples over a 1.9-cm (id) column packed with about 22 cm of
Octolig ® at a rate of 10 mL/min (50-mL aliquots were collected)

| | | | | | |
|---|---|---|---|---|---|
| | | | Species | Eluant | % |
| Species | Fraction | TDS, ppm | Initial ppm* | ppm | removed |

Trial 1 Nitrite enhanced*

| | | | | | |
|---|---|---|---|---|---|
| Sulfate | 5-7 | 632 ± 6 | 30 | BDL | >99 |
| Phosphate | 5-7 | 632 ± 6 | 135 | BDL | >99 |
| Nitrogen | 5 | 631 | 127 | 48 | 62 |
| | 6 | 638 | 127 | 75 | 41 |
| | 7 | 627 | 127 | 86 | 32 |

Trial 2 Nitrite less enhanced**

| | | | | | |
|---|---|---|---|---|---|
| Sulfate | 5-7 | 520 ± 2 | 30 | BDL | >99 |
| Phosphate | 5-7 | 520 ± 2 | 135 | BDL | >99 |
| Nitrogen | 5-7 | 520 ± 2 | 95 | 3.1 ± 0.4 | 97 |

*Trial 1. Calculated values (ppm) were SO₄⁼, 30; PO₄³⁻, 135; NO₃⁻, 18; NO₂⁻, 405. TDS (obs) = 538 ppm
**Trial 2. Calculated values (ppm) were SO₄⁼, 30; PO₄³⁻, 135; NO₃⁻, 18; NO₂⁻, 150. TDS (obs) = 463 ppm

Accordingly the issues of ion competition or selectivity and the capacity of Octolig® were addressed.

### Rate, Selectivity, and Capacity Considerations

The experiments with chromatographic separation have, for the most part been done at one rate, i.e., 10 mL/min or 3.2 mL/min/cm², with the latter unit taking into consideration the area of the column section. In a repetition of the experiment described in Table 2 (Trial 2), a rate of 50 mL/min or 16 mL/min/cm² was used. No difference was observed, i.e., >99% of the phosphate was removed, and 99% of the nitrogen species was removed. The extent of discrimination, i.e., presumably an order of anion removal would be expected to be: PO₄³⁻>SO₄⁼>NO₂⁻>NO₃⁻. But this order presumes a pH great enough to form the orthophosphate ion, rather than hydrogen phosphate or dihydrogen phosphate ions, and at pH values near 7 or 8, the position of phosphorus might be between sulfate and nitrite. The pH of the mixture (Table 2) was 8.65, and given the values of acidity constants for phosphoric acid (Moeller, T.; Martin, D. F. Laboratory Chemistry; D. C. Heath: Boston, Mass., 1965; 269) (K₁=7.5×10⁻³, K₂=6.2×10⁻⁸, and K₃=10⁻¹²), the hydrogen phosphate ion would be the expected prevalent species, as would be seen from the master-variable plot. (Sillén, L. G. Master variables and activity scales; In Equilibrium Concepts in Natural Water Systems, Stumm, W. Symp Chairman.; Adv. Chem. Ser. 67, American Chemical Society: Washington, D.C., 1967; 45-56).

Accordingly in an effort to determine the degree of ease of removal, a discrimination test was devised. The rate was maintained the same, but the length of packed column was reduced to 5 cm. The results are summarized in Table 4. From these data, effectiveness plots were constructed, i.e., percent removal as a function of volume starting with fraction 4. Specifically, a linear relationship was assumed for the defining equations y=ax+h where y=% removal for either phosphorus or for nitrogen, a was the slope and h was the y intercept. The pertinent values were calculated using regression analysis and are listed in Table 5. In addition, two extrapolations were made, i.e., the y-axis intercept and the x-axis intercept. The former was of interest to show the maximum percent recovery for a given fraction which was 107% for phosphate and 61% for nitrogen species. The former value, exceeding 100%, possibly reflects the limitation of a linear model, that in fact a sigmoidal relationship exists with an extensive linear portion, but it also indicates that Octolig® has an encapsulation preference for phosphate (100%) over uni-negative nitrogen species (61%). The x-axis intercept would indicate the volume at which the percent recovery extrapolates to zero percent. And given the difference between the last lowest nitrogen percent recovery ˜5%, the linear extrapolation to y=0, seems to reflect a good approximation to a linear relationship. From this value of x, extrapolated volume in milliliters, it is possible to calculate the amount of the species encapsulated, and this comparison is made in Table 5.

TABLE 4
Competition study: Effect of passage of ion samples over a 1.9-cm (id)
column packed with about 5 cm of Octolig ® at a rate of 10 mL/min
(50-mL aliquots were collected)

| | | | Species | Eluant | % |
|---|---|---|---|---|---|
| Species | Fraction | TDS, ppm | Initial ppm* | ppm | removed |
| Sulfate | 5-7 | 381 ± 5 | 30 | 8.5 | 72 |
| Phosphate | 5 | 385 | 135 | 17 | 87 |
| Phosphate | 6 | 384 | ″ | 41 | 70 |
| Phosphate | 7 | 375 | ″ | 70 | 48 |
| Nitrogen | 5 | 385 | 48.3 | 28 | 42 |
| Nitrogen | 6 | 384 | ″ | 36 | 25.5 |
| Nitrogen | 7 | 374 | ″ | 46 | 4.8 |

Calculated values (ppm) were SO₄⁼, 30;
PO₄³⁻, 135;
NO₃⁻, 12;
NO₂⁻, 150.
TDS (obs) = 320 ppm

TABLE 5
Defining equations for the competition study (Table 4), y = ax + b
where y is the percent removal and x is the volume eluted starting
with Fraction 4.

| Species | a | b | r² | y = 0, x = (mL) | Capacity, mg |
|---|---|---|---|---|---|
| Phosphate | −0.393 | 107.6 | 0.997 | 275 | 37 |
| Nitrogen | −0.373 | 61.43 | 0.996 | 165 | 8 |

A second approach to the extent of ion selectivity by encapsulation was devised. Excess concentrations of the species listed in Table 2 were used and a standard column, i.e., 22 cm of packing was used. The point was to use a large concentration of each species so that the more favorable species for encapsulation would be selected over the greater length of the column. This has significance for the effective separation of species given in Table 1. In theory, a selectivity process or anion-exchange process could be envisioned as the eluant traveled down a sufficiently long column. Given a sufficient concentration as well as a sufficiently long column, the order of selectivity given above would apply and were nitrate or nitrite species to be encapsulated, they would be displaced by the phosphate species and the nitrogen species or uni-negative anions would be shifted down the column.

### Scale Considerations

The effect of scale was considered as a factor in the effectiveness of separation. As noted, various volumes were considered. When the column was packed with only 5 cm of Octolig® the volume was 16 cm³, and only adequate removal was obtained (Table 4) for sulfate, phosphate, and nitrogen, presumably because of the limited capacity. With 22 cm of packing, the volume was 69 cm³, and quantitative separation was achieved (Tables 2, 3) for sulfate, phosphate, and nitrogen. The efficacy of removal as a function of volume was a linear relationship, making the reasonable assumption of the origin as a logical point. For phosphate ion, y=9.64x (degree of association, R² was 0.978) and for total inorganic nitrogen, y=4.43x (R²=0.999), where y was percent removed, and x was the height of packing in the column (2.0 cm id). How far the extrapolation extends is uncertain, but it suggests the capacity to scale-up the process, and it also shows an expected distinction between phosphate and nitrogen anions, as indicated by the differences in the slopes of the defining equations.

### Regeneration/Release Potential

Regeneration experiments were done with a column of Octolig® that was saturated with anions for two reasons. First, there is an economic consideration of being able to reuse the treated Octolig®. The second is to test whether the column might release anions should the used Octolig® be buried instead of being regenerated. The column of Octolig® in a saturated condition was treated with deionized water, This experiment revealed that the Octolig® did not readily release phosphate- or the nitrogen-containing species into deionized water. While one might propose testing with drinking water or well water, a more stringent treatment was selected.

Specifically, a significantly alkaline solution (10⁻⁴ M NaOH) was made, which had a pH of 10.7. Reportedly a pH of 10.5 was the upper stability limit of Octolig® as stated on the Metre-General website (worldwideweb.octolig.com (accessed March, 2009)). The NaOH solution was then passed through the column containing the exhausted Octolig®, and 50-mL fractions of eluant were collected and tested for the presence of phosphate and nitrite. Nitrite was chosen because it was the easier and less time consuming nitrogen containing species to test for. Of the 10 fractions that were collected, fractions 2 through 10 had a very slight concentration of phosphate (<1 ppm) and also a very slight concentration of nitrite (<5 ppm). Additionally, the Octolig® column began to turn yellow slowly from the top of the column downward. This was attributed to a decomposition of the Octolig® in the column. Also, the pH of the eluants was tested using the pH meter, and the pH was <7 indicating that the Octolig® was releasing protons into the solution. Though Octolig® did begin to release nitrite and phosphate, it did so at a very slow rate. Therefore, even under the stringent conditions that would not be practical for most applications due to the large quantities of a NaOH that would have to be used in order to cleanse the anions from the column. Though this might seem a failure for regeneration, it appears to be an asset, showing notable anion retention.

It will be appreciated by those skilled in the art that although the correct ionic ratio was used (and appropriately varied), a different situation exists with actual tank wastes. In addition, the compositions must vary from tank to tank, depending upon the pre-disposal history to an uncertain extent.

### Materials and Methods for Example 2

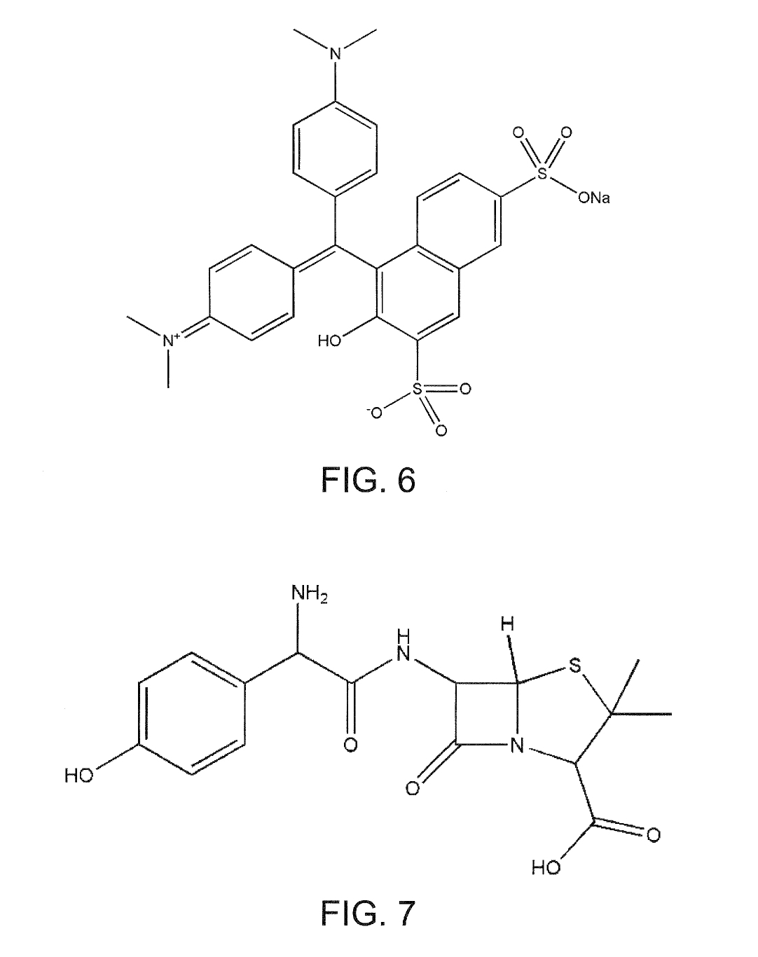

Source of reagents and materials. Octolig® (CAS Registry Number 404899-06-5) was a gift from Metre-General, Inc., Frederick, Colo. ZPS (FIG. 5) was a gift of the Procter & Gamble Company. Lissamine Green B (FIG. 6) and Amoxicillin were obtained from Aldrich Chemical Co.

Well water samples were obtained from a private well (3402 Valencia Road in Original Carrollwood, Tampa, Fla.). Prior to use, the water was filtered through a 3-μ Millipore membrane filter using an all-glass apparatus.

Analyses. As before (5) measurements of total dissolved solid (TDS) of aqueous samples were done by a Fisher Scientific digital conductivity meter, and the pH values were obtained by an Orion model 290A pH/ISE meter connected with an Orion pH triode electrode model 9107BN. Concentrations of dye solutions were acquired from the absorbance measurements using a Shimadzu UV-2401 PC UV-Vis recording spectrophotometer. Spectra were saved to a disk using Origin Pro 8.0 program for further use.

Molar extinction coefficient measurements. Serial dilutions for each model compound and Amoxicillin were prepared from a known stock solution. Absorbance values were recorded for a wavelength near the λₘₐₓ for each dilution using a Shimadzu UV-2401 PC spectrophotometer. Concentrations were prepared to ensure that absorbance values did not exceed OD=1.5. Molar extinction coefficients were determined using the Beer-Lambert law, in which the slope of the absorbance versus concentration plot is equal to the extinction coefficient times the path length, in which the path length was 1.0 cm. The data analysis used EXCEL software and the molar extinction coefficients could be obtained from the linear equations.

Chromatography experiments. The chromatography process was similar to that used before (5, 18-22). Octolig®, as received, was subjected to a pretreatment by suspending the solid in DI water then decanting the water to remove the fines. A Chemglass column, 2 cm (id) equipped with a glass frit and a Teflon stopcock, was packed with Octolig®, and washed with about 1 L of solvent, i.e., DI (deionized) water, tap water, or well water which were used as different matrices. Aqueous samples of dyes were chromatographed using a rate of 10 mL/min using a Spectra/Chron™ peristaltic pump. A series of 50-mL fractions were collected, and measurements were made of conductivity, pH and visible spectra. The concentrations of the effluents (fractions 4 on, typically) were compared with the concentration of the input solutions, and the percent removal was calculated and recorded (Table 8).

### Example 2

### Removal of Selected Pharmaceuticals Using Octolig®

The possibility of removing certain pharmaceuticals from wastewater was tested using Octolig® commercially available material with polyethyldiamine moieties covalently attached to high-surface area silica gel. Selected drugs and drug models were subjected to column chromatography for removal by means of ion encapsulation, the effectiveness of which would depend upon having appropriate anionic functional groups. Removal of methylene blue with quaternary ammonium groups was (statistically) unsuccessful. In contrast, complete success was attained for removal of each of three xanthenylbenzenes (Rose Bengal, Eosin Y, Erythrosine) that have both phenolic and carboxylic acid groups, as is the case with two of the top five prescribed drugs in the United States. Moreover, quantitative removal was obtained for ZPS (zinc phthalocyaninetetrasulfonate) and Lissamine Green B that have sulfonate groups. Finally, quantitative removal was obtained for Amoxicillin, one of the top five most prescribed drugs in the United States (2008).

Pharmaceuticals, also referred to as active pharmaceutical ingredients, are chemical compounds (inorganic or organic) that can be used in the diagnosis, mitigation treatment, or prevention of a disease. (Busser et al., 1999), and because of their efficacy, properties, magnitude of production they can represent a disposal problem. One problem is that pharmaceuticals are widely used for such purposes as human medicine, veterinary medicine, aquaculture, livestock production, agriculture, and bee keeping (5, 15).

In addition, production is concentrated in five countries (Germany, USA, Japan, France, and the United Kingdom) where two-thirds of all pharmaceuticals are produced (25). Failure to attain proper management can lead to environmental contamination. Human usage is also concentrated. According to one estimate (25) 15% of the world population live in high-income countries that use about 90% of the total pharmaceuticals; the United States uses over 52% of all medicines.

A further example of concentration is that hospitals represent a major point-source of environmental contamination. This can arise from improper disposal as well as incomplete metabolism of a given pharmaceutical. As an example, Amoxicillin, a popular antibiotic, was found in a German hospital effluent at a concentration of 920-980 μg/L (14). Considering the 203 hospitals serving 2.47 million patients per day in Florida alone (2006), the impact is widespread (3).

Many individual pharmaceutical compounds and metabolites have been found in the environment and the occurrence of pharmaceuticals has been investigated in many countries, including the E.U. and the U.S. Several studies (2, 10, 11, 13, 14) have noted that pharmaceuticals are present in wastewater treatment plant effluents, hospital wastewater effluents, surface water, ground water, and this will likely result in indirect human exposure to pharmaceuticals via drinking water supplies. A national survey released in 2002 reported that pharmaceuticals, hormones and other organic pollutants were present in more than 80% of surface water streams tested (13). As Heberer (11) noted, more than 80 pharmaceutical active compounds have been detected in the μg/L range in aquatic environments.

While a number of effects might be ascribed to pharmaceuticals in the environment, two problems seem to be especially important: antibiotic-resistant bacteria and endocrine disruptors. Antibiotics are widely used for human medicine, veterinary medicine and agriculture, so there are more obvious environmental issues involving antibiotics (15). The resistant bacteria and, perhaps, multiple-resistant bacteria, may be involved in sewage, soil, or other environmental components. Such bacterial resistance has been detected in wastewater and in sewage-treatment plants (9; 24). Another major concern is that the pharmaceutical compounds, especially endocrine disrupting chemicals (EDCs), are suspected of causing harmful influences to the endocrine systems of human and animals (7).

One may cogently argue that the magnitude of the problem of the environmental contamination is wide-spread and serious (5, 14, 15, 16), the solution to the wide-spread is less evident. More to the point, as Donald Kennedy (a former commissioner of the U.S. Food and Drug Administration) noted antibiotic resistance is expensive (12). The estimated extra costs to the U.S. health care system could be as much as S26 billion a year (12).

One solution in the United States would be for Congress to pass the Preservation of Antibiotics for Medical Treatment Act, albeit some 30 years late (12). This was essentially done in Denmark in the late 1990s, and, according to Kennedy (12) the reservoir of resistant bacteria shrank notably. True, some animals lost weight; others developed infections, but these could be treated, and the costs were less than the benefits achieved (12).

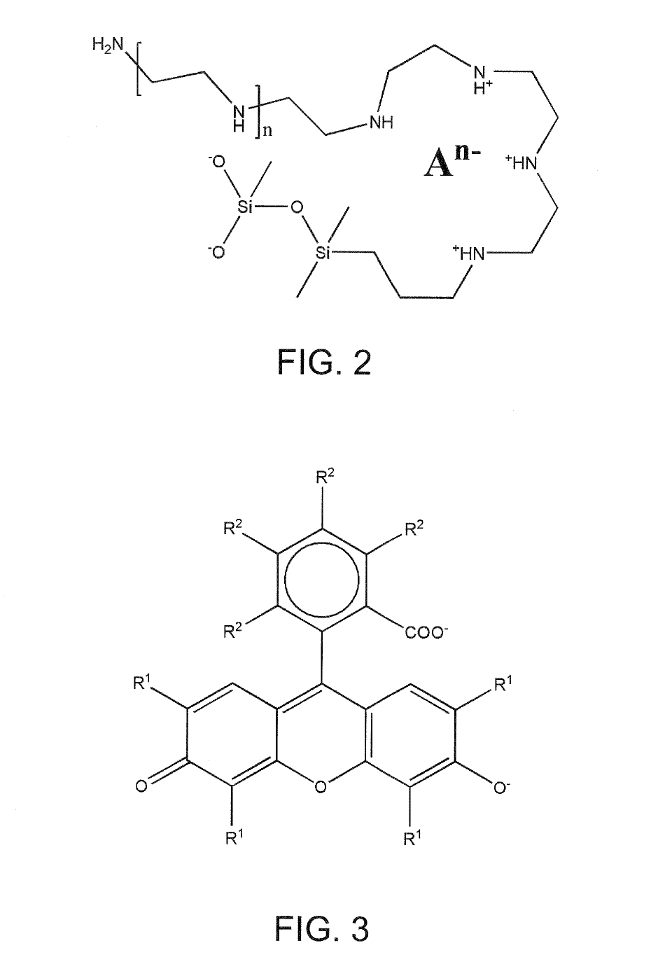

One solution for mitigating point-source contamination may be the use of column chromatography. The present inventor demonstrated that commercially available product, Octolig®, a polyethyleneimine covalently attached to high-surface area silica gel, was able to quantitatively remove anions (nitrate, nitrite, phosphate, sulfate) from aqueous solutions (22). It is postulated that the anions were attached to protonated nitrogens of the Octolig® and became encapsulated by arms of the attached ligands (FIG. 2). Subsequently, it was demonstrated that column chromatography with Octolig® was able to effect quantitative removal of arsenate, chromate, fluoride, molydate, and selenate (20).

This seemed to have implications to a significant environmental problem—environmental contamination of pharmaceuticals—because these drugs typically have certain functional groups that provide solubility as well as electronic properties. Two kinds of functional groups, phenolic and carboxylic, are able to lose protons and turn the pharmaceuticals into anions. It was postulated that such anions could well be attracted to protonated nitrogens of the polyethylenediamino arms of Octolig® (FIG. 2). It is also be postulated a sulfonamide may be hydrolyzed to a sulfonate and accordingly be subject to encapsulation as well.

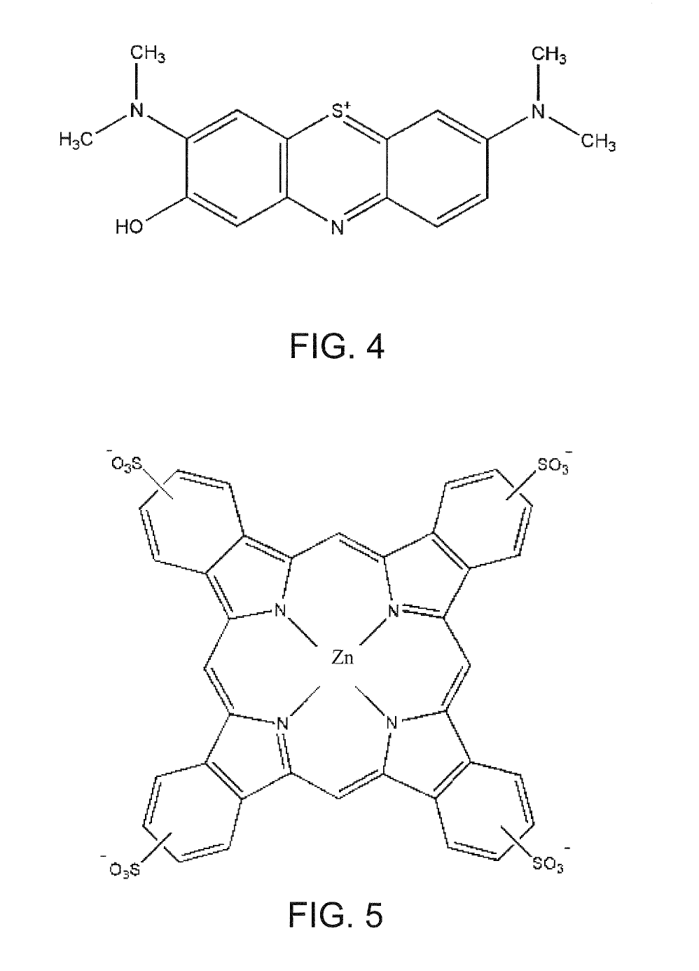

Subsequent research (5) indicated that Octolig®, was able to quantitatively remove three xanthenylbenzenes dyes from aqueous solutions using column chromatography. The three dyes Rose Bengal, Eosin Y, Erythrosine Y (FIG. 3) have phenolic and carboxylic groups that are capable of losing a proton and being encapsulated by protonated Octolig®. Comparative experiments with Methylene Blue, (FIG. 4) were failures, presumably because of proximity of a phenol to a tertiary amine group, minimizing the potential attraction to the encapsulating arm of Octolig®. It was also noted (5) that two of the top five most prescribed drugs in the United States have carboxyl and phenolic groups, i.e., Amoxicillin and Simvastatin (23).

The present study examines other model compounds—zinc phthalocyanine-tetrasulfonate (ZPS, FIG. 5) and Lissamine Green B (FIG. 6)—that contain sulfonates, and in addition, a pharmaceutical, Amoxicillin (FIG. 7), was also tested.

The model compounds (FIG. 3, 4, 5, 6) served three functions: (1) demonstration of efficacy of functional groups for chromatographic removal; (2) a limited, but useful example of the influence of spatial effects, and (3) an indication of the existence or absence of size effects. The applicability of this information to pharmaceuticals can be considered successively.

First, the model compounds demonstrate the efficacy of phenolic, carboxylic, and sulfonic groups in the removal of compounds by chromatography columns packed with Octolig®. Phenolic and carboxylic groups are commonly present in organic pharmaceuticals and serve as a solubilizing function. The xanthenylbenzene derivatives of Rose Bengal, Eosin Y, and Erythrosine each contain phenolic and carboxylic functional groups, and all three compounds were quantitatively removed by column chromatography. The presence of halogens alters the pK_{A} values somewhat and their spectra as well, but did not discernibly affect the efficacy of the process (Table 8) (5). Also, there was no matrix effect, i.e., quantitative recovery values were obtain for a given dye in DI water, tap water, or well water (Table 8) (5). Finally, there was no discernable effect on the percent recovery of switching from one batch to another of Octolig® (Table 8) (5).

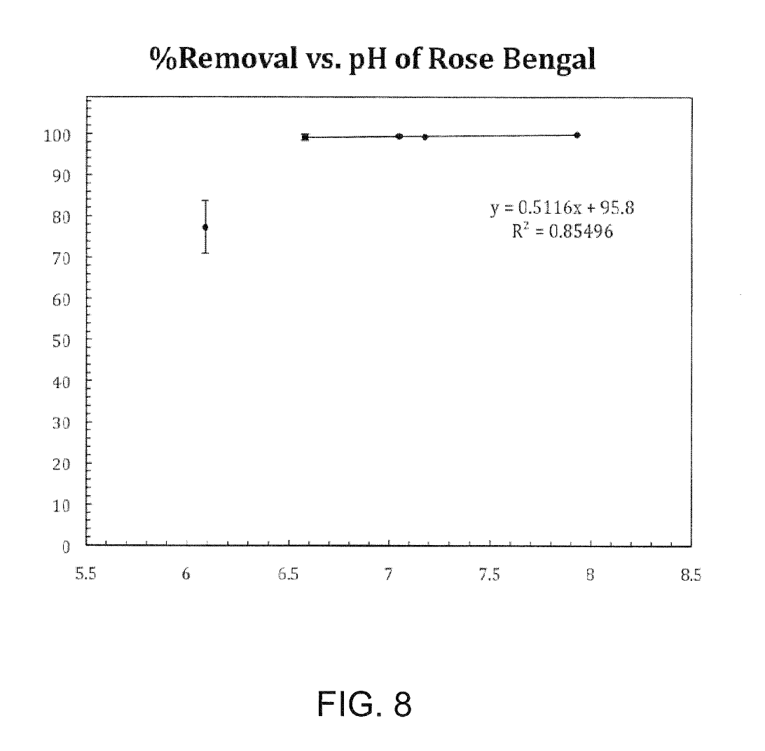

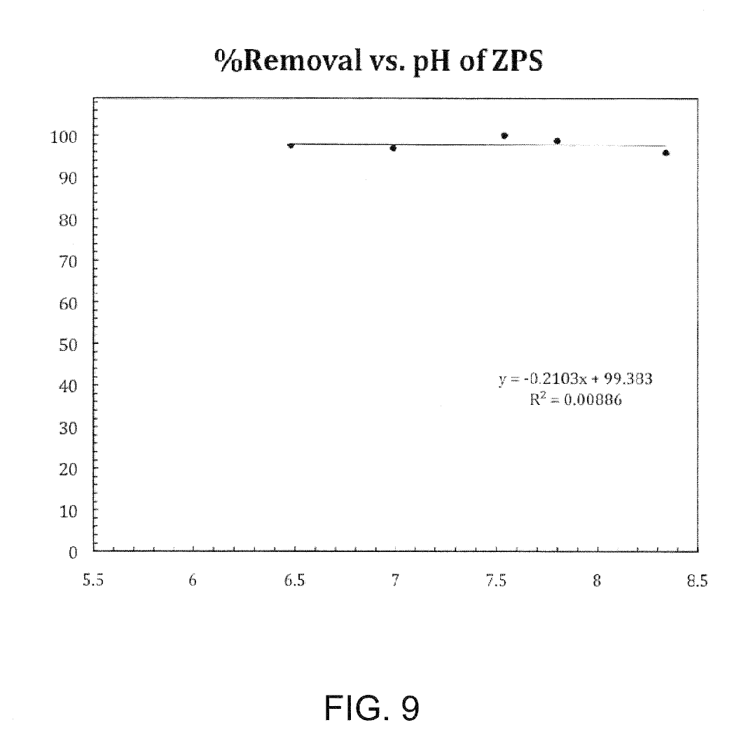

The effect of initial pH on percent removal was notable for aqueous Rose Bengal. At a pH much below 7, the effectiveness was about 76% of the value above pH 7 (FIG. 8). This is to be expected of a derivative of benzoic acid. This particular acid for with the negative log of the dissociation constant (pK_{A}) is 4.2, would be 50% ionized at a pH of 4.2, but completely ionized at a pH of 7.2. Presumably the greater the degree of dissociation, the more favorable removal would be, according to the model presented herein (FIG. 2). In contrast with aqueous Rose Bengal, the removal of zinc phthalocyaninetetrasulfonate (ZPS, FIG. 5) should be independent of pH, owing to the presence of the conjugates of the strongly acidic sulfonic acid, and this was experimentally observed (FIG. 9 or Table 8). Moreover, for Lissamine Green B, for which the anionic groups are sulfonates, the % recovery was also independent of pH over the range studied (ca 6.3-8.3) (Table 9).

Secondly, the behavior of Methylene Blue indicates a steric effect, e.g., an example of adverse steric proximity. From the structure depicted (FIG. 4). It may be noted that there is a aromatic OH function, which should lead to a suitable anion, because the pK_{A} value is 3.8 (1), and at a pH of 7, Methylene Blue should be ionized to an extent exceeding 99%. On the other hand, the hydroxyl function is ortho to a tertiary amine, and the act of proton loss should lead to a tertiary ammonium ion in immediate proximity to a phenolate ion, essentially minimizing any attraction to the protonated Octolig®. And one may note that the percent removal (1.9±1.9%) was essentially zero within experimental error (5).

Thirdly, the model molecules are comparatively large, but still they were effectively removed by chromatography using Octolioge®. The significance of size is two-fold. If the sizeable model molecules can be removed, removal of smaller pharmaceuticals with suitable functional groups, suitably placed may be expected. Accordingly, it should be noted that amoxicillin (characterized by some as a “large” molecule) was quantitatively removed. Without being limited by theory, the second aspect is that the single-arm model represented (FIG. 2) may not apply to molecules of sufficient size, and a two-arm model may be a better representation.

According to data provided by Towner (23), Amoxicillin, Levothyroxine, and Lisinopril are three of the top five prescribed drugs in the USA, and all three contain a carboxylic function Amoxicillin contains both a carboxylate group and a phenolic group (FIG. 7). Of the three, the Amoxicillin seemed to be more promising for study, based on availability and comparative cost, and was selected for study. The data in Table 10 show some of the important characteristics of the data obtained with the five model compounds, including no matrix effect (DI water vs. well water), quantitative removal, a slight effect of pH, but quantitative above pH=7.

Aminopenicillins such as Amoxicillin have a short half-life in the aquatic environment as noted in a recent study (Lamm, 2009). However, the authors noted a concern that hypersensitivity-inducing drugs, such as penicillins and theirdegradation products may elicit allergic reactions in human consumers of water and food of animal origin (16).

The ability to remove Amoxicillin from water samples using chromatography with Octolig® has implications for examples of point-source pollution such as hospitals. The success described here deserves further study.

In addition, the anion removal procedure described here could be applicable to removal of tetracycline and monoensin, two antibiotics commonly used to treat dairy cattle. Tetracycline has a phenolic moiety and monoensin has a carboxylic acid group (6). In south Florida, many dairy farms have cows in air-conditioned facilities with lagoons to catch the mist water that provides cooling and carries off waste. And some 70% of the antibiotics are allegedly secreted in active form (8).

On the other hand, research at Michigan Tech has been directed at using vetiver grass to remove these antibiotics (8). The grass is native to India and has been grown in artificial wetlands in efforts to treat wastewater. It is reported to be noninvasive and vigorous and evidently has been used to remove TNT from water. Using a hydropononic study system, Michigan Tech, all of the tetracycline and 95.5% of the monoensin disappeared during a 12-week study.

### REFERENCES

### Example 2

1. Anon. Methylene Blue (71-783-4) Chemical Book. http://www.chemicalbook.com/ProductMSDSDetailCB2748858_EN.htm Accessed Apr. 22, 2010.
2. Boyd, G. R.; Reemtsma, H.; Grimm, D. A.; Mitra, S. Pharmaceuticals and personal care products (PPCPs) in surface and treated waters of Louisiana, USA and Ontario, Canada. The Sci. of the Total Environ., 331: 135; 2003.
3. Bureau of the Census. Statistical abstract of the United States, 128th ed., Community Hospitals-States: 2000 and 2006. Table 165. Washington, D.C.: United States Department of Commerce; 2009.
4. Buser H. R.; Poiger, T.; Muller, M. D. Occurrence and environmental behavior of the chiral pharmaceutical drug Ibuprofen in surface water and wastewater. Environ. Sci. Technol., 33: 2529; 1999.
5. Chang, W.-S.; Martin, D. F.; Small, M. Use of model compounds to study removal of pharmaceuticals using Octolig®. Technol. Innov. In press; 2010.
6. Duax, W. L:., G. D. Smith, and P. D Strong. Complexation of metal ions by monesin. Crystal and molecular structure of hydrated and anhydrous crystal forms of sodium monesin. J. Am. Chem. Soc. 102: 6725; 1980.
7. Ghijsen, R. T.; Hoogenboezem, W. Endocrine disrupting compounds in the Rhine and Meuse Basin-occurrence in surface, process, and drinking water, sub-project of the National Research Project on the occurrence of endocrine disrupting compounds. Association of river waterworks-RIWA, De Eendracht, Schiedam, Netherlands, 96; 2000.
8. Goodrich, M. Grass shows promise for removing antibiotics from water. Water Online Apr. 26, 2010. http://www.waterline.comiarticle.mve/Grass-shows-Promise-For-Removing-Antibiotics. Accessed May 3, 2010.
9. Guardabassi, L.; Petersen, A.; Olsen, J. E.; Dalsgaard, A. Antibiotic resistance in Acinetobacter spp. Isolated from sewers receiving waste effluent from a hospital and a pharmaceutical plant. Appl. Environ. Microbiol., 64: 3499; 1998.
10. Halling-Sørensen, B.; Nielsen, S. N.; Lanzky, P. F.; Ingerslev, F.; Lutzhoft, H. C.; Jorgensen, S. E. Occurrence, fate and effects of pharmaceutical substances in the environment a review. Chemosphere, 36: 357; 1998
11. Heberer, T. Occurrence, fate, and removal of pharmaceutical residues in the aquatic environment: a review of recent research data. Toxicol. Letters, 131: 5; 2002.
12. Kennedy, D. Cows on drugs. Sunday opinion Op-ed., New York Times, Apr. 18, 2010 WK 11.
13. Kolpin, D. W.; Furlong, E. T.; Meyer, M. T.; Thurman, E. M.; Zaugg, S. D.; Barber, L. B.; H. T. Buxton, H. T. Pharmaceuticals, hormones, and other organic wastewater contaminants in US streams, 1999-2000: a National Reconnaissance. Environ. Sci. Technol, 36: 1202; 2002
14. Kümmerer, K. Drugs in the environment: emission of drugs, diagnostic aids and disinfectants into wastewater by hospitals in relation to other sources—a review. Chemisphere 45: 957; 2001.
15. Kümmerer, K. Significance of antibiotics in the environment. J. Antimicrob. Chemotherapy, 52:5; 2003.
16. Kümmerer, K., ed., Pharmaceuticals in the environment. Sources, Fate, effects and risk, (3^{rd} ed.): Berlin, Heidelberg: Springer; 2008.
17. Lamm, A.; Gozlan, I.; Rotstein, A.; Avisar, D. Detection of amoxicillin-2′,5′ J. Environ. Sci. Hlth, Part A. 44:1512; 2009.
18. Martin, D. F.; Aguinaldo, J. S.; Kondis, N. P.; Stull, F. W.; O'Donnell, L. F.; Martin, B. B.; and Alldredge, R. L.; Comparison of Effectiveness of removal of nuisance anions by metalloligs, metal derivatives of Octolig®, J. Environ. Sci. Hlth., 43A: 1296; 2008.
19. Martin, D. F., N. P. Kondis, and R. L. Alldredge. Effectiveness of removal of aqueous perchlorate by Cuprilig, a copper(II) derivative of Octolig, J. Environ. Sci. Hlth., Part A, 44:188; 2009.
20. Martin, D. F.; Lizardi, C. L.; Schulman, E.; Vo, B.; and Wynn, D. Removal of selected nuisance anions by Octolig®, J. Environ. Sci. Hlth., Part A, 45:: in press; 2010.
21. Martin, D. F.; O'Donnell, L.; Martin, B. B.; Alldredge, R. Removal of aqueous nuisance anions with Ferrilig. J. Environ. Sci. Hlth, 43A: 700; 2008.
22. Stull, F. W.; Martin, D. F. Comparative ease of separation of mixtures of selected nuisance anions (nitrate, nitrite, sulfate, phosphate) using Octolig®. J. Environ. Sci. Hlth., Part A 44: 1551; 2009.
23. Towner, B. The fifty most prescribed drugs. AARP Bulletin. October 2009, Washington, D.C.;
24. Witte, W. Medical; consequences of antibiotic use in agriculture. Science, 279:996; 1998.
25. World Health Organization. 2004. The World Medicines Situation. http://www.ops.org.bo/textocompleto/ime23901.pdf. Accessed Mar. 12, 2010.

TABLE 8
Passage of aqueous sample over a chromatographic column packed with
Octolig ® at a flow rate of 10 mL/min (50-mL aliquots were collected).*

| Dye, | | Frac- | | Concen- | |
|---|---|---|---|---|---|
| (Matrix) | Batch | tion | pH | tration** | % Removed |
| Rose | | | | | |
| Bengal^{†} | | | | | |
| (Well water) | No. 2 | Stock | 7.93 | 21.921 | — |
| | | 6-10 | 6.74 ± 0.07 | 0.012 ± 0.011 | 99.9 ± 0.0 |
| Eosin Y^{†} | | | | | |
| (DI water) | No. 1 | Stock | 6.27 | 55.185 | — |
| | | 4-10 | 6.24 ± 0.08 | 0.713 ± 0.009 | 87.1 ± 0.2 |
| | No. 1 | Stock | 6.68 | 56.213 | — |
| | | 4-10 | 5.99 ± 0.08 | 0.002 ± 0.005 | 100.0 ± 0.2 |
| | No. 1 | Stock | 6.72 | 86.290 | — |
| | | 4-10 | 5.98 ± 0.08 | 0.035 ± 0.031 | 100.0 ± 0.0 |
| | No. 2 | Stock | 6.83 | 90.044 | — |
| | | 4-10 | 5.88 ± 0.04 | 0.927 ± 0.065 | 99.0 ± 0.1 |
| (Well water) | No. 2 | Stock | 7.97 | 85.167 | — |
| | | 6-10 | 6.70 ± 0.09 | 0.054 ± 0.037 | 99.9 ± 0.0 |
| Erythrosine^{†} | | | | | |
| (DI water) | No. 2 | Stock | 8.66 | 78.753 | — |
| | | 4-10 | 6.13 ± 0.10 | 0.046 ± 0.027 | 99.9 ± 0.0 |
| (Tap water) | No. 2 | Stock | 7.76 | 94.897 | — |
| | | 4-10 | 7.45 ± 0.08 | 0.122 ± 0.019 | 99.9 ± 0.0 |
| (Well water) | No. 2 | Stock | 8.33 | 105.566 | — |
| | | 4-10 | 8.42 ± 0.06 | 1.504 ± 0.070 | 98.6 ± 0.1 |

*Taken in part from Chang and co-workers (5)
**Concentrations as μM

TABLE 9
Passage of aqueous sample of dyes over a 2.0-cm id chromatographic column packed
with ~60 mL of Octolig ® at a flow rate of 10 mL/min (50-mL aliquots were collected).

| | | | | | | |
|---|---|---|---|---|---|---|
| Dye, | | | | | | |
| Matrix | Batch | Fraction | TDS, ppm | pH | Concentration* | % Removed |

ZPS

| | | | | | | |
|---|---|---|---|---|---|---|
| DI water | 1 | Stock | 16 | 6.99 | 126.29 | — |
| | | 4-10 | 23.3 ± 3.7 | 6.79 ± 0.16 | 3.860 ± 0.159 | 96.9 ± 0.1 |
| | 2 | Stock | 17 | 7.80 | 22.77 | — |
| | | 4-10 | 19.4 ± 0.9 | 6.45 ± 0.30 | 0.264 ± 0.034 | 98.8 ± 0.2 |
| Well water | 2 | Stock | 183 | 7.54 | 4.081 | — |
| | | 4-10 | 234.1 ± 3.9 | 7.09 ± 0.16 | 0.000 ± 0.000 | 100.0 ± 0.0 |
| | 2 | Stock | 175 | 8.34 | 67.335 | — |
| | | 4-10 | 342.6 ± 3.1 | 7.17 ± 0.05 | 2.730 ± 0.090 | 95.9 ± 0.4 |
| DI water | 2 | Stock | 16 | 6.48 | 57.219 | — |
| | | 4-10 | 18.3 ± 0.8 | 6.43 ± 0.05 | 1.424 ± 0.145 | 97.5 ± 0.0 |

Lissamine green B†

| | | | | | | |
|---|---|---|---|---|---|---|
| DI water | 1 | Stock | 9 | 6.27 | 9.087 | — |
| | | 4-10 | 8.1 ± 0.3 | 6.20 ± 0.10 | 0.017 ± 0.005 | 99.8 ± 0.1 |
| | 1 | Stock | 10 | 6.24 | 9.294 | — |
| | | 4-10 | 6.9 ± 0.4 | 6.10 ± 0.13 | 0.008 ± 0.005 | 99.9 ± 0.1 |
| Well water | 2 | Stock | 169 | 8.09 | 7.636 | — |
| | | 4-10 | 211 ± 6 | 6.64 ± 0.14 | 0.005 ± 0.001 | 99.9 ± 0.0 |
| | 2 | Stock | 174 | 7.92 | 7.542 | — |
| | | 4-10 | 213 ± 5 | 6.64 ± 0.10 | 0.002 ± 0.002 | 100 ± 0.0 |
| | No. 2 | Stock | 175 | 7.88 | 0.74 | — |
| | | 4-10 | 216 ± 4 | 6.92 ± 0.01 | 0.002 ± 0.001 | 99.7 ± 0.1 |

*Concentration as μM.
†A 3.0-cm id chromatographic column was used packed with ~130 mL of Octolig ®

TABLE 10
Passage of aqueous amoxicillin samples over a 3.0-cm id chromatographic column
packed with passage of aqueous amoxicillin sample over a 3.0-cm id chromatographic
column packed with ~130 mL of Octolig ® at a flow rate of 10 mL/min
(50-mL aliquots were collected).-

| Matrix | Fraction | TDS, ppm | pH | Concentration, 10⁶M | % Removed |
|---|---|---|---|---|---|
| DI water | Stock | 4 | 6.17 | 839.269 | — |
| | 4-10 | 6 ± 0 | 7.01 ± 0.18 | 4.945 ± 3.653 | 99.4 ± 0.4 |
| | Stock | 3 | 6.19 | 1229.808 | — |
| | 4-10 | 6 ± 1 | 6.83 ± 0.07 | 2.885 ± 3.092 | 99.8 ± 0.3 |
| | Stock | 5 | 5.97 | 741.346 | — |
| | 4-10 | 2 ± 1 | 5.59 ± 0.10 | 17.170 ± 9.594 | 98.8 ± 0.6 |
| Well water | Stock | 119 | 6.56 | 750.000 | — |
| | 4-10 | 176 ± 14 | 6.48 ± 0.06 | 11.676 ± 0.012 | 99.2 ± 0.4 |
| | Stock | 153 | 7.12 | 912.500 | — |
| | 4-10 | 193 ± 24 | 6.72 ± 0.06 | 57.418 ± 22.258 | 96.9 ± 1.2 |

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

What is claimed is:

1. A method of removing one or more anions from a solution, comprising contacting the solution with branched polyalkyleneimine moieties attached to a substrate under conditions that allow association between the polyalkyleneimine moieties and one or more anions if present in the solution.

2. The method of claim 1, wherein the solution comprises hospital wastewater effluent, wastewater treatment plant effluent, medical research facility wastewater effluent, surface water, or ground water.

3. The method of claim 1, wherein the conditions that allow association between the polyalkyleneimine moieties and one or more anions comprise a pH within the range of 7.0-8.0.

4. The method of claim 1, wherein said method further comprises adjusting the pH of the solution to a pH that allows association between the polyalkyleneimine moieties and the one or more anions, and wherein said adjusting is carried out prior to, or simultaneously with, said contacting.

5. The method of claim 4, wherein said adjusting of the pH comprises raising the pH of the solution.

6. The method of claim 4, wherein said adjusting of the pH comprises lowering the pH of the solution.

7. The method of claim 1, wherein the polyalkyleneimine moieties are polyethyleneimines, wherein the substrate is a high surface-area silica gel, and wherein the polyalkyleneimine moieties are covalently attached to the high surface-area silica gel.

8. The method of claim 1, wherein said contacting comprises running the solution through at least one ion-association composite, where the at least one ion-association composite comprises the polyalkyleneimine moieties attached to the substrate.

9. The method of claim 8, further comprising subjecting the solution to electrochemistry after running the solution through the at least one ion-association composite.

10. The method of claim 9, wherein the at least one ion-association composite is packed into a column at least 5 cm in length.

11. The method of claim 1, wherein the one or more anions comprise one or more from among arsenate, arsenite, nitrate, nitrite, phosphate, sulfate, selenate, selenite, perchlorate, and molybdate.

12. The method of claim 1, wherein the one or more anions are constituents of a compound comprising one or more functional groups capable of losing one or more protons to become anionic.

13. The method of claim 12, wherein the one or more functional groups comprise at least a phenolic group, a carboxylic group, a sulfonic group, or a combination of two or more of the foregoing groups.

14. The method of claim 1, wherein the one or more anions comprise an active pharmaceutical ingredient (API), or a moiety of an API.

15. The method of claim 1 wherein the one or more anions comprise a dye, or a moiety of a dye.

16. The method of claim 1, wherein the silica substrate comprises a gel or particles.

17. An apparatus for removing one or more anions from a solution, comprising branched polyalkyleneimine moieties attached to a substrate; and a pH adjuster.

18. The apparatus of claim 17, wherein said substrate is a high surface-area silica gel.

19. A kit for removing one or more anions from a solution, comprising branched polyalkyleneimine moieties covalently attached to a substrate; and printed instructions for carrying out anion removal from the solution.

20. The kit of claim 19, further comprising an acid for lowering the pH of the solution, a base for raising the pH of the solution, or both an acid and a base.
